(19) United States
(12) Patent Application Publication
(10) Pub. No.: US 2015/0131921 A1
(43) Pub. Date: May 14, 2015

(54) CODING AND DECODING METHOD FOR IMAGES OR VIDEOS

(71) Applicant: Peking University, Beijing (CN)

(72) Inventors: Tiejun Huang, Beijing (CN); Wen Gao, Beijing (CN); Siwei Ma, Beijing (CN)

(21) Appl. No.: 14/534,780

(22) Filed: Nov. 6, 2014

(30) Foreign Application Priority Data
Nov. 7, 2013 (CN) 201310551681/6

(51) Int. Cl. H04N 19/20; H04N 19/44; H04N 19/91

(52) U.S. Cl. CPC H04N 19/20; H04N 19/91; H04N 19/44
USPC 382/233; 382/243; 382/236

(57) ABSTRACT

A coding and decoding method for images or videos is provided by embodiments of the present invention to improve coding and decoding efficiency. The method includes: establishing a visual dictionary, wherein, the visual dictionary includes one or more visual words; extracting features from a specific object in an image; determining whether there is a visual word in the visual dictionary matching the specific object by using a feature matching method; obtaining the index of the visual word matched and a geometric relationship between the specific object and the visual word matched, wherein, the geometric relationship is represented by a project parameter; entropy coding the index of the visual word matched and the project parameter instead of entropy coding the specific object.

### CROSS-REFERENCE TO RELATED APPLICATION

This application claims priority from CN Patent Application Serial No.201310551681.6, filed on Nov. 7 2013, the entire contents of which are incorporated herein by reference for all purposes.

### FIELD OF THE INVENTION

The present invention is related to computer coding and decoding technology, especially related to a coding and decoding method for images or videos.

### BACKGROUND OF THE INVENTION

In the prior art, most of the coding or decoding method and coder or decoder thereof are based on analysis of the code of images and videos themselves, and further redundant image pixels are compressed to improve coding or decoding efficiency.

With the development of local feature technology of images and videos, another coding or decoding method appears in the prior art. Instead of compressing image pixels, image features are extracted and compressed; and at a decoding side, images are then reconstructed with reference to the image features and a large-scaled image feature database.

However, even image features are used to code or decode images, the size of data content is still very large.

### SUMMARY OF THE INVENTION

A new coding and decoding method for images or videos are provided by embodiments of the present invention to further improve coding or decoding efficiency.

In an embodiment of the present invention, a coding method for images or videos provided includes:

establishing a visual dictionary, wherein, the visual dictionary includes one or more visual words;

extracting features from a specific object in an image;

determining whether there is a visual word in the visual dictionary matching the specific object, by using a feature matching method;

obtaining the index of the visual word matched and a geometric relationship between the specific object and the visual word matched; wherein, the geometric relationship is represented by a project parameter;

entropy coding the index of the visual word matched and the project parameter instead of entropy coding the specific object.

In an embodiment of the present invention, a decoding method for images or videos provided includes:

entropy decoding a code stream to obtain an index and a project parameter of a visual word;

obtaining an image of a visual object from a visual dictionary according to the index of the visual word;

adjusting the image of the visual object with reference to the project parameter;

overlapping all of the adjusted images of the visual objects to obtain a decoded image.

By using the technical scheme of the present invention, only the index of a specific object in a visual dictionary and corresponding geometric relationship information are included in a code stream of an image, so that the size of data content in the code stream is greatly reduced. Moreover, the decoding process must refer to the visual dictionary, in this case, even the code stream is captured, the code stream still cannot be decoded without the corresponding visual dictionary, thus the safety of the code stream is guaranteed.

### BRIEF DESCRIPTION OF THE DRAWINGS

FIG. 1 illustrates a flow chart of a coding method for images or videos.

FIG. 2 illustrates a flow chart of a feature matching method or videos.

FIG. 3 illustrates a framework of a coding method for images or videos.

FIG. 4 illustrates a flow chart of a decoding method for images or videos.

### DETAILED DESCRIPTION OF THE INVENTION

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be through and complete, and will fully convey the scope of the invention to those skilled in the art. Among other things, the present invention may be embodied as systems, methods or devices. The following detailed description should not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on”. The term “coupled” implies that the elements may be directly connected together or may be coupled through one or more intervening elements. Further reference may be made to an embodiment where a component is implemented and multiple like or identical components are implemented.

While the embodiments make reference to certain events this is not intended to be a limitation of the embodiments of the present invention and such is equally applicable to any event where goods or services are offered to a consumer.

Further, the order of the steps in the present embodiment is exemplary and is not intended to be a limitation on the embodiments of the present invention. It is contemplated that the present invention includes the process being practiced in other orders and/or with intermediary steps and/or processes.

In a coding method for images provided by an embodiment of the present invention, a visual dictionary is established to include those visual objects appearing with high frequency, and each visual object corresponds to a standard visual word in the visual dictionary. When an image is to be coded, it is determined that whether the image includes a visual word; if the image includes a visual word, the image is coded with reference to the index of the visual word and the relationship between the visual word and the image.

By using a coding method for images or videos provided by an embodiment of the present invention, the size of data content in a video stream is further reduced and coding efficiency is improved.

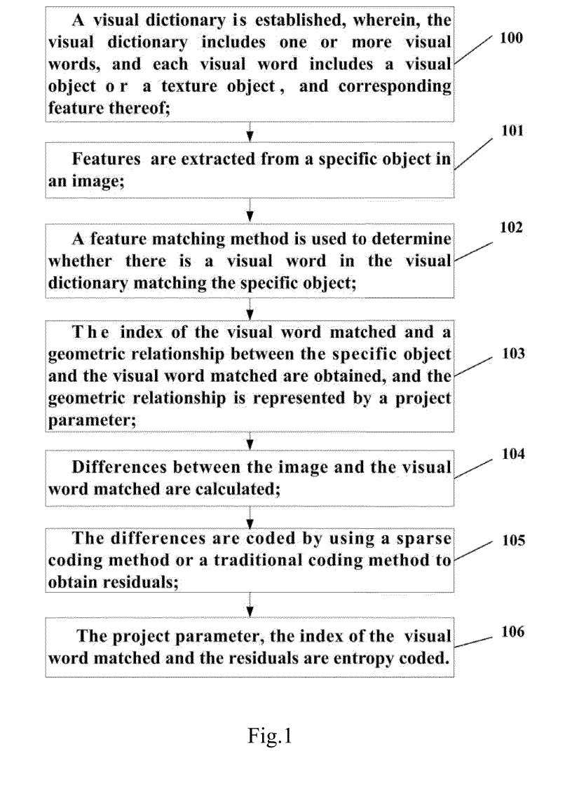

A coding process for images or videos provided by an embodiment of the present invention is described in detail as follows. FIG. 1 illustrates a flow chart of a coding method for images or videos. As shown in FIG. 1, the method includes following steps.

Step 100: a visual dictionary is established, wherein, the visual dictionary includes one or more visual words, and each visual word includes a visual object or a texture object, and corresponding features thereof

In an embodiment of the present invention, the visual object or texture object in the visual dictionary may be represented by an image. For example, if the visual object is Tiananmen Square, then an image of Tiananmen Square and corresponding features of the image are stored in the visual dictionary.

The corresponding features may include local features and/or global features. Specifically, the global features may describe color histograms, color matrixes or co-occurrence matrixes of gray level; or may be obtained by combining local features. These global features only represent global information of the image, and cannot represent objects contained in the image. The local features have sufficient description and distinction ability to describe image features. The local features usually include one or more lower-layer expressions, which may be expressions describing one or more circular areas, and the local features cannot visually describe visual objects.

Step 101: features are extracted from a specific object in an image to be coded.

It should be noted that, the image to be coded is different with the image of a visual object or texture object in the visual dictionary.

Step 102: a feature matching method is used to determine whether there is a visual word in the visual dictionary matching the specific object of the image to be coded.

Step 103: the index of the visual word matched and a geometric relationship between the specific object and the visual word matched are obtained, and the geometric relationship is represented by a project parameter; the project parameter may include magnification, deflation, rotation, affine, relative position and so on.

Those skilled in the art can understand, there may not one or more visual words in the visual dictionary matching the specific object or specific objects of the image to be coded. The indexes of all of the visual words found and the geometric relationships between the specific object and each of its corresponding visual words are obtained.

Step 104: differences between the image and all of visual words matched are calculated.

Specifically, according to the project parameter obtained, in order to form a projected image, each visual object or textual object of a visual word is projected to a corresponding position of a blank image which has the same size with the image to be coded; and then the projected image is subtracted from the image to be coded to obtain the differences.

Step 105: the differences are coded by using a sparse coding method or a traditional coding method to obtain residuals.

Step 106: the project parameter and the index of the visual word matched, both of which are obtained in Step 103, and the residuals obtained in Step 105 are entropy coded.

The entropy coding method may be based on a prior coding standard, which includes fixed length coding, variable length coding or arithmetic coding, etc.

Those skilled in the art can understand that, in the coding method described above, orders of some steps are changeable, and the changes of the orders will not affect effect of the present invention.

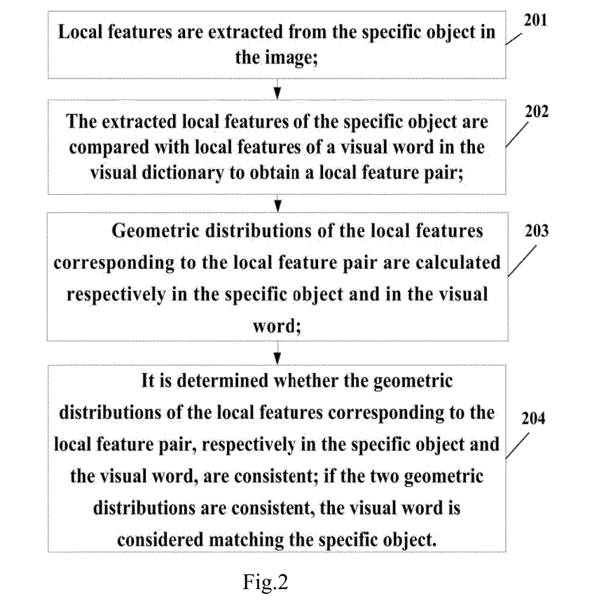

In an embodiment of the present invention, a feature matching method, as shown in FIG. 2, may be used to determine whether there is a visual word in a visual dictionary matching a specific object of the image to be coded. The method includes following steps.

Step 201: local features are extracted from the specific object in the image. Herein, SIFT algorithm may be used to extract the local features of the specific object.

Step 202: the extracted local features of the specific object are compared with local features of a visual word in the visual dictionary to obtain a local feature pair. The local feature pair includes two identical or similar local features respectively extracted from the specific object and obtained from the visual word. The two local features which similarity degree is within a threshold range would be considered as similar.

Step 203: geometric distributions of the local features corresponding to the local feature pair are calculated respectively in the specific object and the visual word.

Step 204: it is determined whether the geometric distributions of the local features corresponding to the local feature pair, respectively in the specific object and the visual word, are consistent; if the two geometric distributions are consistent, the visual word is considered matching the specific object, and it is further considered that the image to be coded contains the visual object or the texture object corresponding to the visual word.

For example, 1000 local features are extracted from a specific object and 800 local features are obtained from a visual word, and 200 local feature pairs are obtained through feature comparisons. Then geometric distributions of the local features corresponding to each of the 200 local feature pairs are calculated respectively in the specific object and the visual word. If the geometric distributions of the local features corresponding to each of the 200 local feature pairs, respectively in the specific object and in the visual word, are considered as consistent, it is considered that the specific object includes an object corresponding to the visual word. In an embodiment of the present invention, only when the number of the local feature pairs, which have a consistent relationship of projective transformation (such as magnification, deflation, rotation, affine, etc.) in the visual word or the specific object, reaches a certain threshold, the geometric distributions of the local features corresponding to the local feature pairs are considered as consistent.

In an embodiment of the present invention, in order to improve feature matching efficiency, local features of each specific object may be combined to obtain a global feature; in the same way, local features of each visual word may be combined to obtain a global feature too. Then the visual dictionary is searched for one or more candidate visual words with the most similar global feature with that of the specific object; then local features of the specific object are compared with that of the one or more candidate visual words respectively. By using this method, the feature matching efficiency can be further improved.

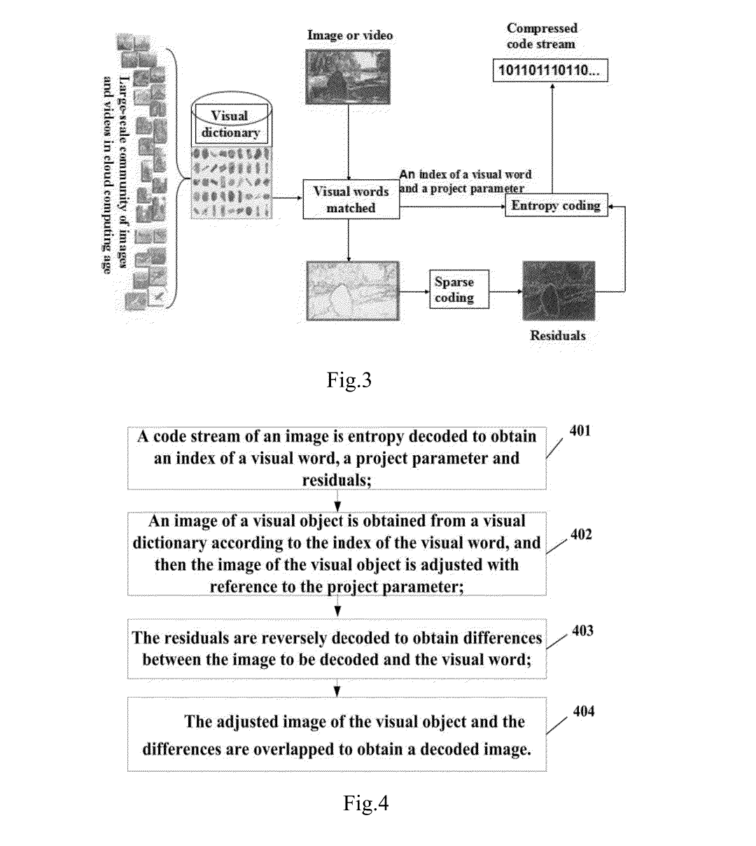

FIG. 3 illustrates a framework of a coding method for images. As shown in FIG. 3, coding an image of “Beijing University Weiming Lake (used as “Lake” for simplicity)” is used as an example to illustrate the coding process provided by an embodiment of the present invention.

Following visual words including visual objects such as the sky, Beijing University learned tower (a tower located by the side of the Lake, used as “tower” for simplicity), a Stele, and their corresponding local features, are stored in a visual dictionary in advance. Visual words including textual object such as trees, water, gravel road, and their corresponding local features are also stored in the visual dictionary. When the image of “Lake” is to be coded, the specific objects of the image are compared with the visual words in the visual dictionary one-by-one firstly, then visual words such as the sky, tower, Stele, trees, water and gravel road are found, and then indexes of the visual words matched and their corresponding project parameters are obtained. Then the image of “Lake” is compared with the visual words matched to obtain differences; the differences are coded by using a sparse coding method or a traditional coding method to obtain residuals. Finally, the indexes of the visual words matched, the corresponding project parameters and the residuals are entropy coded instead.

FIG. 4 illustrates a flow chart of a decoding method for images. As shown in FIG. 4, the method includes following steps.

Step 401: a code stream of an image is entropy decoded to obtain an index of a visual word, a project parameter and residuals.

The entropy decoding method corresponds to the entropy coding method illustrated in Step 106.

Step 402: an image of a visual object is obtained from a visual dictionary according to the index of the visual word, and then the image of the visual object is adjusted with reference to the project parameter.

Specifically, according to the project parameter obtained, the image of the visual object obtained from the visual dictionary is adjusted by being projected to a corresponding position of a blank image, which has the same size with the image to be decoded.

It should be noticed that, the image of the visual object stored in the visual dictionary and used to represent the visual object, is different from the limitation “image” referring to the image to be coded or decoded in the embodiments of the present invention.

Step 403: the residuals are reversely decoded to obtain differences between the image to be decoded and the visual word.

Step 404: the adjusted images of the visual objects and the differences are overlapped to obtain a decoded image.

Those skilled in the art can understand that, the orders of Step 402 and Step 403 are exchangeable.

The above embodiments are only preferred embodiments of the present invention and cannot be used to limit the protection scope of the present invention. Those skilled in the art can understand that, the technical scheme of the embodiment may still be modified or partly equivalently substituted; and the modification or substitution should be considered within the spirit and protection scope of the present invention.

1. A coding method for images or videos, comprising:
establishing a visual dictionary, wherein, the visual dictionary comprises one or more visual words;
extracting features from a specific object in an image;
determining whether there is a visual word in the visual dictionary matching the specific object by using a feature matching method;
obtaining the index of the visual word matched and a geometric relationship between the specific object and the visual word matched;
wherein, the geometric relationship is represented by a project parameter;
entropy coding the index of the visual word matched and the project parameter instead of entropy coding the specific object.

2. The method of claim 1, further comprising:
calculating differences between the image and the visual word matched;
coding the differences by using a sparse coding method or a traditional coding method to obtain residuals;
entropy coding the residuals with the index of the visual word matched and the project parameter .

3. The method of claim 1, wherein, each visual word comprises a visual object or a texture object, and corresponding features thereof

4. The method of claim 1, wherein, the project parameter comprises magnification, deflation, rotation, affine, relative position.

5. The method of claim 1, wherein, determining whether there is a visual word in the visual dictionary matching the specific object comprises:
comparing extracted local features of the specific object with local features of a visual word in the visual dictionary to obtain a local feature pair which comprises two identical or similar local features respectively extracted from the specific object and obtained from the visual word;
calculating geometric distributions of the local features corresponding to the local feature pair, respectively in the specific object and in the visual word;
determining whether the geometric distributions of the local features corresponding to the local feature pair, respectively in the specific object and the visual word, are consistent; considering the visual word as matching the specific object if the two geometric distributions are consistent.

6. The method of claim 5, wherein, before comparing extracted local features of the specific object with local features of a visual word in a visual dictionary, the method further comprises:
combining the local features of each specific object to obtain a global feature;
searching the visual dictionary for a candidate visual word with the most similar global feature with that of the specific object.

7. The method of claim 6, wherein, SIFT algorithm is used to extract the local features of the specific object.

8. A decoding method for images or videos, comprising:
entropy decoding a code stream of an image to obtain an index and a project parameter of a visual word;
obtaining an image of a visual object from a visual dictionary according to the index of the visual word;
adjusting the image of the visual object with reference to the project parameter;
overlapping adjusted images of all of visual objects to obtain a decoded image.

9. The method of claim 8, further comprising:
entropy decoding the code stream to obtain residuals;
reversely decoding the residuals to obtain differences between the image to be decoded and the visual word;
overlapping the adjusted image of all of the visual objects and the differences to obtain a decoded image.
